(19) United States
(12) Patent Application Publication
(10) Pub. No.: US 2018/0007130 A1
(43) Pub. Date: Jan. 4, 2018

(54) Peer-to-Peer Assisted Personal Synchronization

(71) Applicant: Microsoft Technology Licensing, LLC, Redmond, WA (US)

(72) Inventors: Brandon T. Hunt, Redmond, WA (US); Alexander Burba, Seattle, WA (US); Avi Cohen, Demarest, NJ (US)

(73) Assignee: Microsoft Technology Licensing, LLC, Redmond, WA (US)

(21) Appl. No.: 15/199,962

(22) Filed: Jun. 30, 2016

(51) Int. Cl. H04L 29/08; H04L 12/24

(52) U.S. Cl. CPC H04L 67/1046; H04L 67/1095; H04L 41/06; H04L 41/082

(57) ABSTRACT

In one example, a catalog service may use a peer-to-peer network to distribute a data content item across multiple associated user devices. The catalog service may maintain a device group list describing a device group and a content catalog for the device group listing a data content set stored in the device group. The catalog service may identify a content change to the data content set listed in the content catalog at a seed device of the device group. The catalog service may send an update alert to a leeching device of the device group of the content change to trigger the leeching device to receive the content change over a peer-to-peer network between the seed device and the leaching device.

### BACKGROUND

A user may have multiple computing devices, such as laptop, desktop, set-top box, tablet, smart phone, or other user devices. Further, those computing devices may be shared between multiple household members. Content generated on one computing device may be stored on a network storage service, or “cloud service”, to protect the data in the event that a computing device becomes damaged. Further, the other computing devices associated with the user may then download from the network storage service any data content items stored by the first computing device, sharing content across each device of a user.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to using a peer-to-peer network to distribute a data content item across multiple associated user devices. The catalog service may maintain a device group list describing a device group and a content catalog for the device group listing a data content set stored in the device group. The catalog service may identify a content change to the data content set listed in the content catalog at a seed device of the device group. The catalog service may send an update alert to a leeching device of the device group of the content change to trigger the leeching device to receive the content change over a peer-to-peer network between the seed device and the leaching device.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a personal device network.

FIG. 2 illustrates, in a block diagram, one example of a peer-to-peer network.

FIG. 3 illustrates, in a block diagram, one example of a computing device.

FIG. 4 illustrates, in a block diagram, one example of a data content set record for a device group.

FIG. 5 illustrates, in a flowchart, one example of a method of managing an active peer list on a catalog service.

FIG. 6 illustrates, in a flowchart, one example of a method of tracking a data content item on a catalog service.

FIG. 7 illustrates, in a flowchart, one example of a method of storing a network copy of a data content item on a catalog service.

FIG. 8 illustrates, in a flowchart, one example of a method of storing an updated version of a data content item on a catalog service.

FIG. 9 illustrates, in a flowchart, one example of a method of alerting a leeching device to a data content item with a catalog service.

FIG. 10 illustrates, in a flowchart, one example of a method of alerting a leeching device to an updated version of a data content item with a catalog service.

FIG. 11 illustrates, in a flowchart, one example of a method of transferring a data content item to a leeching device with a member device of a device group.

FIG. 12 illustrates, in a flowchart, one example of a method of transferring an updated version of a data content item to a leeching device with a member device of a device group.

FIG. 13 illustrates, in a flowchart, one example of a method of receiving a data content item from a seed device with a member device of a device group.

FIG. 14 illustrates, in a flowchart, one example of a method of receiving an updated version of a data content item from a seed device with a member device of a device group.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a catalog service, a computing device, or a machine-implemented method.

In one example, a catalog service may use a peer-to-peer network to distribute a data content item across multiple associated user devices. The catalog service may maintain a device group list describing a device group and a content catalog for the device group listing a data content set stored in the device group. The catalog service may identify a content change to the data content set listed in the content catalog at a seed device of the device group. The catalog service may send an update alert to a leeching device of the device group of the content change to trigger the leeching device to receive the content change over a peer-to-peer network between the seed device and the leaching device.

A traditional peer-to-peer system may manage non-personal content, matching peer devices based on requested content identifiers. Each peer device may then create a peer-to-peer connection with the matched peer devices in order to access the identified content. Such an approach for personal content syncing may produce a lot of limitations using traditional peer-to-peer systems, such as massive catalogs and low probability of finding peers for the unique content.

Conversely, a peer-to-peer network may use a user identifier centric system to find and manage peer devices. The peer-to-peer network may rely on a network-based, or “cloud”-based, catalog service. The catalog service may return peer devices based on a user account logged into the user devices, as opposed to the content identifier. Thus, a personal device may use a peer-to-peer network with other personal devices to directly distribute new data content items and updates to existing data content items without accessing a server via the Internet to collect the items. Specifically, a client may determine a data content set as a candidate for synchronization. Next the client may access a catalog service and receive a list of device candidate that might have that data. Finally, the client may initiate a peer-to-peer connection to each device candidate to acquire the content from these peers.

Additionally, to optimize client-service communication, the catalog service may tag certain content as “recent”. A peer device may synchronize the metadata of the “recent” content to the catalog service for distribution to the other clients. The other clients may determine an optimal source for receiving the update. The catalog service may create a catalog digest that encapsulates the metadata for recent documents with source devices. The catalog digest may allow the client to save time on interrogation of each peer device, and instead focus on connecting to an optimal source.

The catalog service may group the devices according to a group identifier. The group identifier may be based on one or more user identifiers or household identifiers tied to a user account. A household identifier may refer to one or more associated user accounts, such as spousal accounts or parent and child accounts. The device group may have an associated set of data content, with each data content item uniquely identified by both the data content item and the version of the data content item. The catalog service may track which user device in the device group has a specific version of a specific data content item.

The user devices in the device group may establish a peer-to-peer network between the devices in order to transfer data content between devices. Each peer device in a peer-to-peer network may interact on an equal privilege basis, as opposed to a server client relationship. When a user device changes the overall data content set for the device group, such as by adding a data content item to the data content set or updating an existing data content item in the data content set, the user device may alert the catalog service to update a content catalog maintained in a network storage service, or “cloud”. The catalog service may then alert other devices in the device group to the content change. Rather than using the catalog service as a conduit to receive the content change, the other device may use the peer-to-peer network to receive the content change directly. Then, after a sufficient number of user devices have been seeded with the current version of a data content item, the catalog service may quickly and efficiently draw sub-pieces of the content change from each of the seed devices to create a backup copy of the content change for storage in the network storage service.

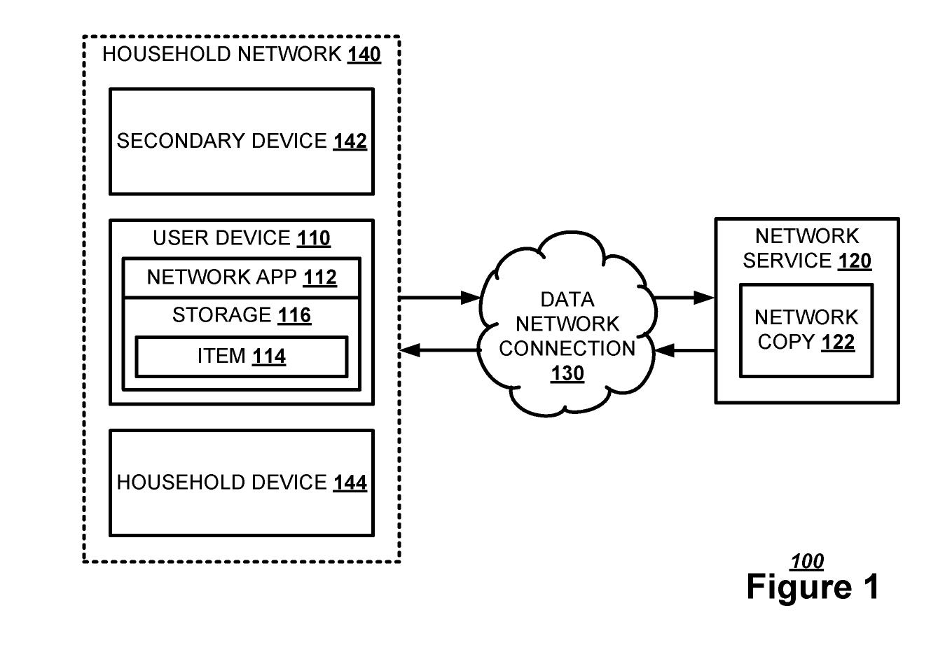

FIG. 1 illustrates, in a block diagram, one example of a personal device network 100. A user may use a user device 110 that executes a network storage application 112 to access a network storage service 120 via a data network connection 130. The user device 110 may be a desktop computer, a laptop computer, a tablet, a smart phone, a dedicated media player, or a gaming console. The network storage service 120 may be implemented on a single server or a distributed set of servers, such as a server farm. The data network connection 130 may be an Internet connection, a wide area network connection, a local area network connection, or other type of data network connections.

The user device 110 may store a data content item 114 in a local data storage 116. The data content item 114 may be a text file, an image file, an audio file, a video file, a data file, or an executable file. The network storage application 112 may store a network copy 122 of the data content item 114 in the network storage service 120.

Further, the user device 110 may be a part of a household network 140 of user devices. A household network 140 may have a secondary device 142 tied to a user account associated with the user device 110. The household network 140 may also have a household device 144 tied to a household user account tied to a user account associated with the user device 110, such as spousal user accounts or parent and child user accounts.

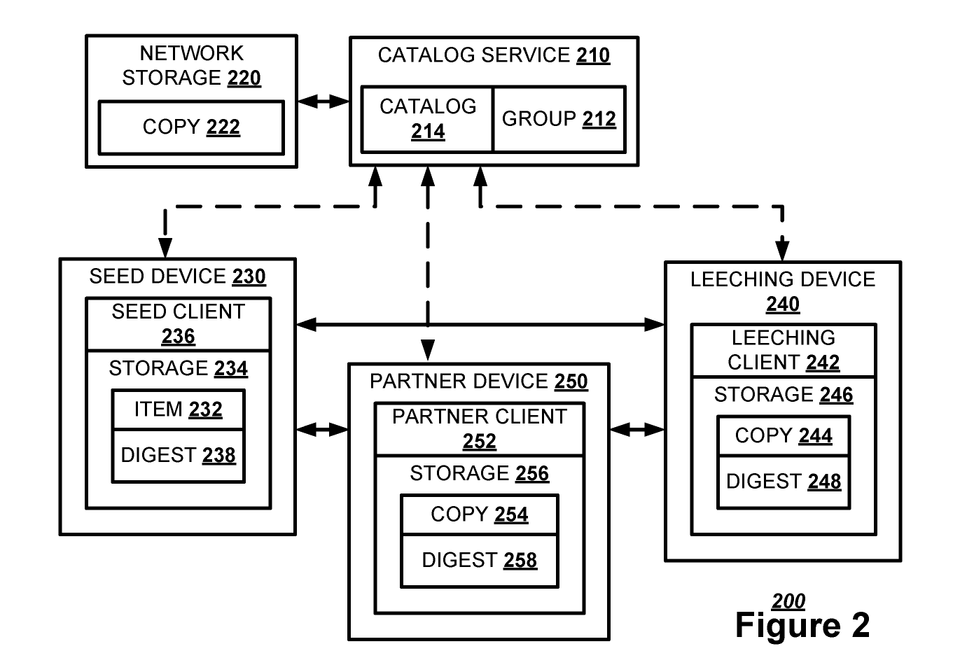

Transferring a data content item from a user device to other user devices via a network storage service may be slow and resource intensive. Creating a peer-to-peer network between the group devices may allow for more efficient transference of data content items. FIG. 2 illustrates, in a block diagram, one example of a peer-to-peer network 200. A catalog service 210 may maintain a device group list 212 describing a device group associated with a group identifier. The catalog service 210 further may maintain a content catalog 214 to list each member of a data content set stored in the device group. The catalog service 210 may have a network storage 220 to store a network copy 222 of the data content set.

A device group may form a peer-to-peer network 200 between the active peer devices in the device group. The catalog service 210 may use the content catalog 214 to identify a source device of the device group for a content change to the data content set. The source device is a member device of the device group that has made a content change to the data content set, such as by adding a data content item or updating an existing data content item. The source device may notify the catalog service 210 upon making the content change. The source device may act as a seed device 230 to propagate the content change to other devices in the device group. Each active peer device of the device group may act as a seed device 230. A seed device 230 is a peer device in the peer-to-peer network 200 that provides a data content item 232 or an updated version of a data content item 232 to other devices in the peer-to-peer network 200. The seed device 230 may store the data content item 232 in a seed storage device 234 local to the seed device 230. Each seed device 230 may execute a seed client 236 to connect to the peer-to-peer network 200. The seed client 236 may maintain a local seed digest 238 of the content catalog 214 in the seed storage device 234. The seed digest 238 may contain the full data stored in the content catalog 214, a listing of just the data content items relevant to that seed device 230, or a listing of the most recent changes to the content catalog 214. The seed client 236 may divide the data content item 232 or the updated version of the data content item 232 into a set of sub-pieces of equal or varying data sizes. Alternately, the seed client 236 may divide just the edits to the data content item 232 into a set of sub-pieces. The seed client 236 may then send the set of sub-pieces to other peer devices in the peer-to-peer network 200.

The catalog service 210 may identify a set of one or more seed devices 230 of the peer-to-peer network 200 to a leeching device 240 of the peer-to-peer network 200. A leeching device 240 is a peer device in the peer-to-peer network that is receiving a copy of the data content item 232 from the seed devices 230. A peer device may be both a leeching device 240 and a seed device 230 depending on circumstances. The leeching device 240 may execute a leeching client 242 to connect to the peer-to-peer network 200. The leeching client 242 may collect the sub-pieces of the data content item 232 from the one or more seed devices 230 on the peer-to-peer network 200. The leeching client 242 may merge the sub-pieces into a leeching copy 244 of the data content item in a leeching storage 246 of the leeching device 240. The leeching client 242 may maintain a local leeching digest 248 of the content catalog 214 in the leeching storage device 246.

Further, the catalog service 210 may identify a set of one or more seed devices 230 and one or more leeching devices 240 of the peer-to-peer network 200 to a partner device 250 of the peer-to-peer network 200. A partner device 250 is a peer device in the peer-to-peer network that facilitates an exchange of a copy of the data content item 232 between a seed device 230 and a leeching device 240. A partner device 250 may act as both a leeching device 240 and a seed device 230. The partner device 250 may execute a partner client 252 to connect to the peer-to-peer network 200. The partner client 252 may collect a seed subset of sub-pieces of the data content item 232 from one or more seed devices 230 on the peer-to-peer network 200 while collecting a leeching subset of complementary sub-pieces of the leeching copy 244 from the leeching device 240. A complementary sub-piece is a sub-piece of a data content item that is not a part of the seed subset. The partner client 252 may merge the seed subset of sub-pieces and the leeching subset of sub-pieces into a partner copy 254 of the data content item in a partner storage 256 of the partner device 250. The partner client 252 may maintain a local partner digest 258 of the content catalog 214 in the partner storage device 256. Additionally, the partner client 252 may forward the seed subset of sub-pieces to the leeching device 240 while receiving the leeching subset of sub-pieces. Thus, the peer-to-peer network may quickly populate the leeching device 240 with a leeching copy 244 of the data content item and the partner device 250 with a partner copy 254 of the data content item simultaneously.

The peer-to-peer network 200 may backup the content change to the data content set on the peer devices to the network storage 220. By leveraging the distribution of copies of the content change across multiple peer devices, the peer-to-peer network may also distribute the backup function across peer devices. The catalog service 210 may collect a seed subset of sub-pieces of the data content item 232 from one or more seed devices 230 on the peer-to-peer network 200 while collecting a leeching subset of complementary sub-pieces of the leeching copy 244 from the leeching device 240 and a partner subset of complementary sub-pieces of the partner copy 254 from the partner device 250. The catalog serviced 210 may merge the seed subset of sub-pieces, the leeching subset of sub-pieces, and the partner subset of sub-pieces into a network copy 222 of the data content item in the network storage 220. By distributing the backup function across multiple member devices, the peer-to-peer network 200 may reduce strain on resources and speed up the backup process.

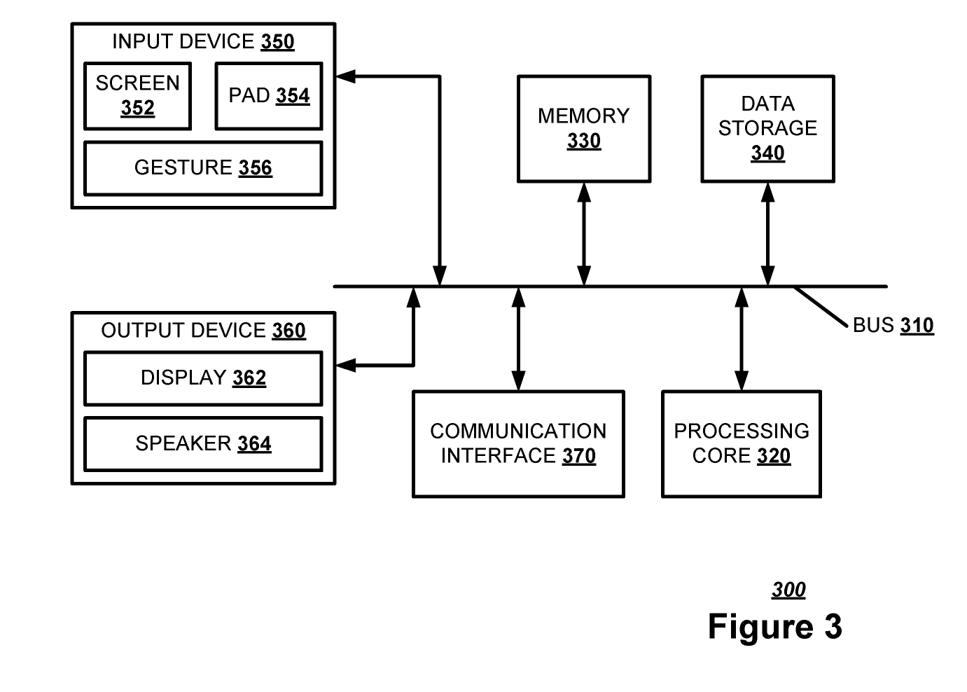

FIG. 3 illustrates a block diagram of an exemplary computing device 300 which may act as a peer device or a catalog service. The computing device 300 may combine one or more of hardware, software, firmware, and system-on-a-chip technology to implement a peer device or a catalog service. The computing device 300 may include a bus 310, a processing core 320, a memory 330, a data storage 340, an input device 350, an output device 360, and a communication interface 370. The bus 310, or other component interconnection, may permit communication among the components of the computing device 300.

The processing core 320 may include at least one conventional processor or microprocessor that interprets and executes a set of instructions. The processing core 320 may be configured to identify a content change to the data content set listed in the content catalog at a seed device of the device group. The content change may be at least one of an addition of a data content item to the data content set or an updated version of an existing data content item in the data content set. The processing core 320 may be configured to identify the item leeching device as having yet to receive the data content item. The processing core 320 may be also configured to merge sub-pieces of a content change into a network copy of the content change stored in the catalog service. The processing core 320 may be additionally configured to merge sub-pieces of a content change received from a seed device subset of the device group into a network copy of the content change stored in the catalog service. The seed device subset encompasses peer devices providing a sub-piece of the content change to the catalog service.

The memory 330 may be a random access memory (RAM) or another type of dynamic data storage that stores information and instructions for execution by the processor 320. The memory 330 may also store temporary variables or other intermediate information used during execution of instructions by the processor 320. The memory 330 may be configured to store a series of instructions that are executed by at least one processor to implement a catalog service application. The memory 330 may be configured to maintain a device group list describing a device group. The memory 330 may be further configured to maintain a content catalog for the device group listing a data content set stored in the device group. The memory 330 may be also configured to tag the data content item for tracking by the catalog service. The memory 330 may be additionally configured to associate the device group with a group identifier describing at least one of a user identifier and a household identifier. The memory 330 may be further configured to store a version identifier indicating the data content item and a version of the data content item.

The data storage 340 may include a conventional ROM device or another type of static data storage that stores static information and instructions for the processor 320. The data storage 340 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 340 may store a set of instructions detailing a method that when executed by one or more processors cause the one or more processors to perform the method. The data storage 340 may also be a database or a database interface for storing a device group list, a data content set list, or a network copy of a data content item.

The input device 350 may include one or more conventional mechanisms that permit a user to input information to the computing device 300, such as a keyboard, a mouse, a voice recognition device, a microphone, a headset, a touch screen 352, a touch pad 354, a gesture recognition device 356, etc. The output device 360 may include one or more conventional mechanisms that output information to the user, including a display screen 362, a printer, one or more speakers 364, a headset, a vibrator, or a medium, such as a memory, or a magnetic or optical disk and a corresponding disk drive.

The communication interface 370 may include any transceiver-like mechanism that enables computing device 300 to communicate with other devices or networks. The communication interface 370 may include a network interface or a transceiver interface. The communication interface 370 may be a wireless, wired, or optical interface. The communication interface 370 may be configured to send an update alert to a leeching device of the device group of the content change to trigger the leeching device to receive the content change over a peer-to-peer network between the seed device and the leeching device. The communication interface 370 may be further configured to identify an item seed device subset storing at least one sub-piece of the content change to the leeching device of the device group to trigger the leeching device to receive the at least one sub-piece over the peer-to-peer network between the seed device subset and the leeching device. The communication interface 370 may be also configured to receive a catalog update from the seed indicating a content change to the data content set. The communication interface 370 may be additionally configured to upload at least one sub-piece of a content change of the data content set from each seed device in a seed device subset of the device group. A member device may have a sub-piece of the content change, but be considered outside the seed device subset if not providing that sub-piece to the catalog service.

The computing device 300 may perform such functions in response to processor 320 executing sequences of instructions contained in a computer-readable medium, such as, for example, the memory 330, a magnetic disk, or an optical disk. Such instructions may be read into the memory 330 from another computer-readable medium, such as the data storage 340, or from a separate device via the communication interface 360.

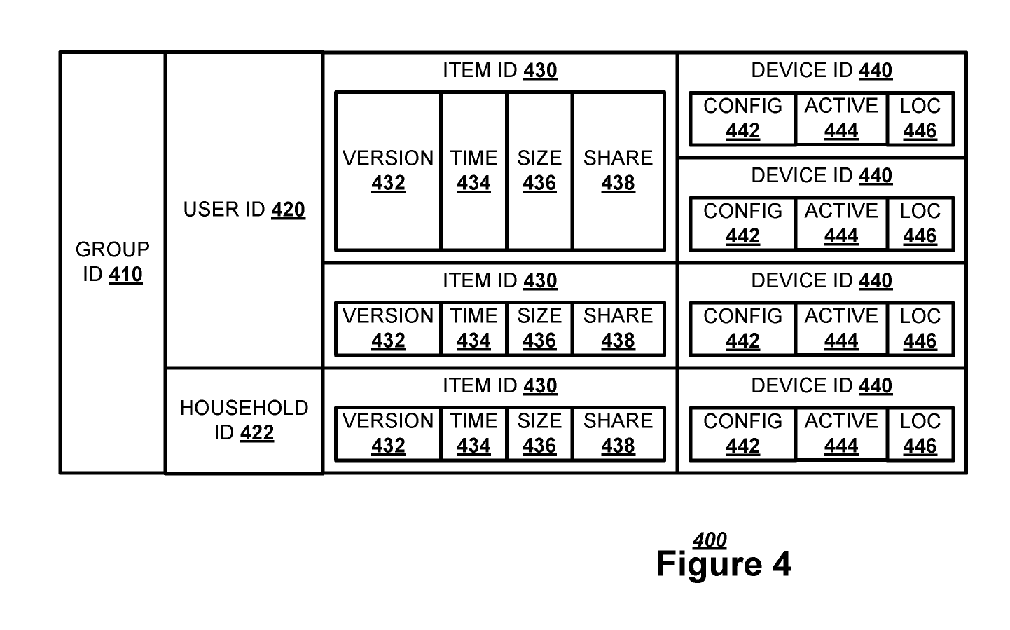

FIG. 4 illustrates, in a block diagram, one example of a data content set record 400 for a device group. The device group record 400 may have a group identifier (ID) 410 indicating a group of devices associated with a user group. The user group may be a household of users, or some other group that would share user devices and data content. The device group record 400 may have one or more user identifiers 420 indicating user accounts associated with the user group. Alternately, the group identifier 410 may be associated with a household identifier 422 indicating a user account shared by multiple users.

Each user identifier 420 or household identifier 422 may be associated with one or more item identifiers 430 indicating a data content item maintained by the associated user account. The item identifier 430 may have a version identifier 432 indicating the most recent version of the data content item. The item identifier 430 may have a timestamp 434 indicating the creation time of the most recent version. The catalog service may use the timestamp 434 to sort the content items to focus on just the most recently updated versions. The item identifier 430 may further have a size field 436 describing the data size of the data content item. The item identifier 430 may also have a share flag 438 indicating whether a data content item is to be shared across user accounts or across user devices.

Each item identifier 430 may be associated with one or more device identifiers 440 indicating user devices storing that version of the data content item. A user device may be associated with multiple users in a user group. The device identifier 440 may be associated with a configuration field 442 describing a software or a hardware configuration of the user device. The catalog service may limit sharing to certain devices even if the user account has permission to access a data content item if the associated device does not have a hardware or software configuration compatible with that data content item. The device identifier 440 may be also associated with an active flag 444 indicating whether an active alert has been received from the user device within an active period. The device identifier 440 may be further associated with a location field 446 describing a location of the user device, either in terms of a geographic location or a virtual network location.

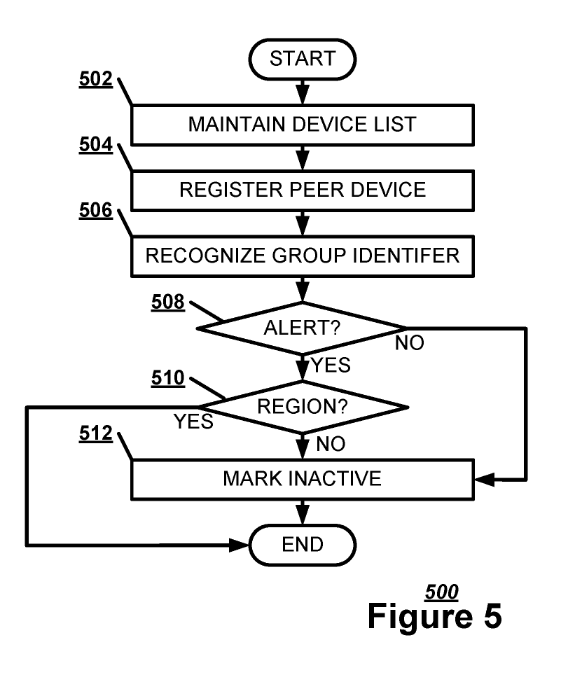

FIG. 5 illustrates, in a flowchart, one example of a method 500 of managing a device group list on a catalog service. The catalog service may maintain a device group list describing active peer devices in a peer-to-peer network for a device group (Block 502). The catalog service may register a peer device as being an active peer device executing a peer client (Block 504). The catalog service may recognize a group identifier indicating the device group for the peer device (Block 506). If the catalog service has not received an active alert from the peer device indicating that the peer device is active within an active period (Block 508), the catalog service may mark the peer device as inactive on the device group list when no active alert has been received within an active period (Block 510). If the catalog service determines that the peer device is outside a region window for a geographic region for the peer device (Block 512), the catalog service may mark the peer device as inactive on the device group list when outside a region window for a geographic region for the peer device (Block 510). A region window describes a period of time that a peer device may be active within a geographic region, either based on network service policy or local laws.

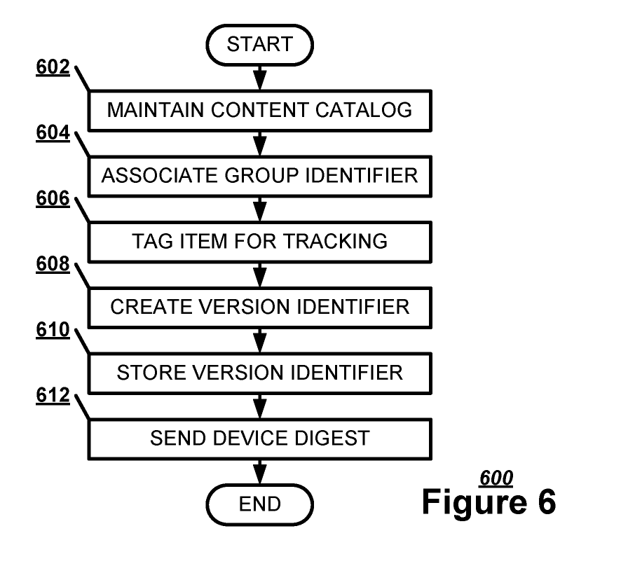

FIG. 6 illustrates, in a flowchart, one example of a method 600 of tracking a data content item on a catalog service. The catalog service may maintain a content catalog for a device group listing a data content set stored in the device group (Block 602). The catalog service may associate the device group with a group identifier describing at least one of a user identifier and a household identifier (Block 604). The catalog service may tag the data content item for tracking (Block 606). The catalog service may create a version identifier indicating the data content item and a version of the data content item (Block 608). The catalog service may store the version identifier indicating the data content item and a version of the data content item in the content catalog (Block 610). The catalog service may send a device digest listing a data content subset for a user device to the user device based on the data content set for the device group (Block 612).

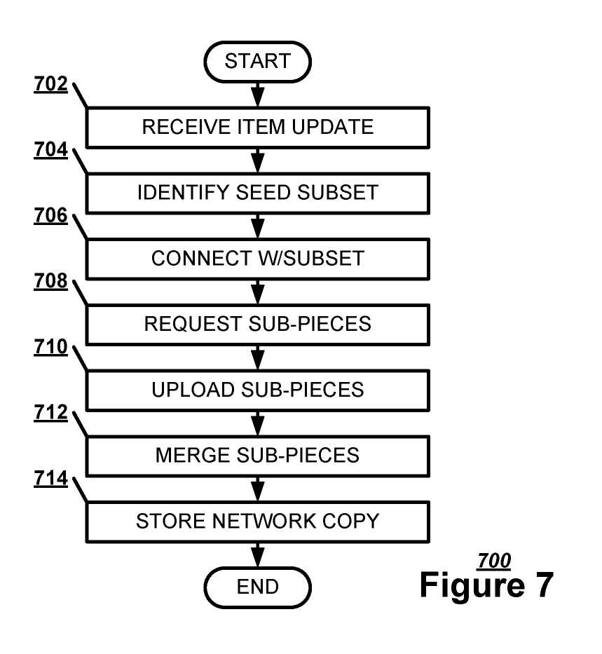

FIG. 7 illustrates, in a flowchart, one example of a method 700 of storing a network copy of a data content item on a catalog service. The catalog service may receive an item catalog update describing a data content item added to the data content set (Block 702). The catalog service may identify an item seed device subset of the device group storing at least one item sub-piece of the data content item (Block 704). The catalog service may connect with the item seed device subset (Block 706). The catalog service may request the at least one item sub-piece of the data content item from each item seed device in the item seed device subset (Block 708). The catalog service may upload the at least one item sub-piece of the data content item from each item seed device in the item seed device subset (Block 710). The catalog service may merge the item sub-pieces of the data content item into a network copy of the data content item (Block 712). The catalog service may store the network copy of the data content item in the network storage (Block 714).

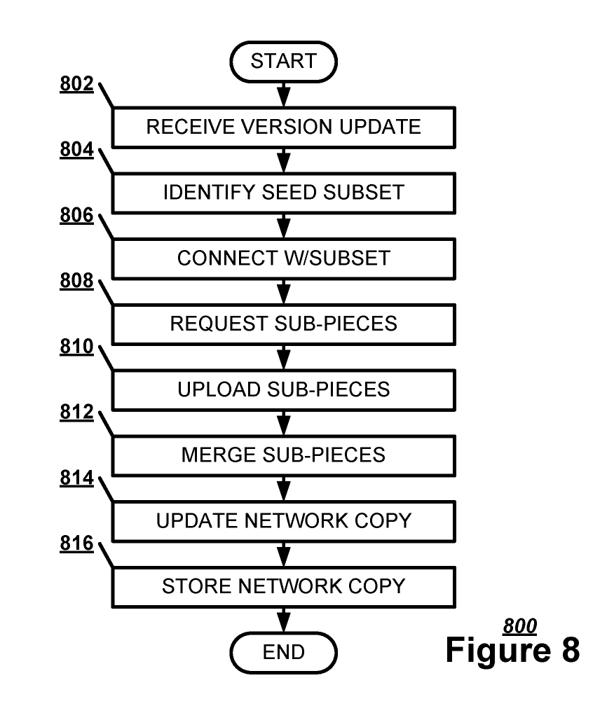

FIG. 8 illustrates, in a flowchart, one example of a method 800 of storing an updated version of a data content item on a catalog service. The catalog service may receive a version catalog update indicating the data content item has been updated to an updated version of the data content item from a member device (Block 802). The catalog service may identify a version seed device subset of the device group storing at least one item sub-piece of the data content item (Block 804). The catalog service may connect with the version seed device subset (Block 806). The catalog service may request the at least one version sub-piece of the data content item from each version seed device in the version seed device subset (Block 808). The catalog service may upload at least one version sub-piece of an updated version of the data content item from each version seed device in a version seed device subset of the device group (Block 810). The catalog service may merge the version sub-pieces of the updated version into a network version copy of the updated version (Block 812). The catalog service may update the network copy of the data content item based on the network version copy (Block 814). The catalog service may store the network copy of the data content item in the network storage (Block 816).

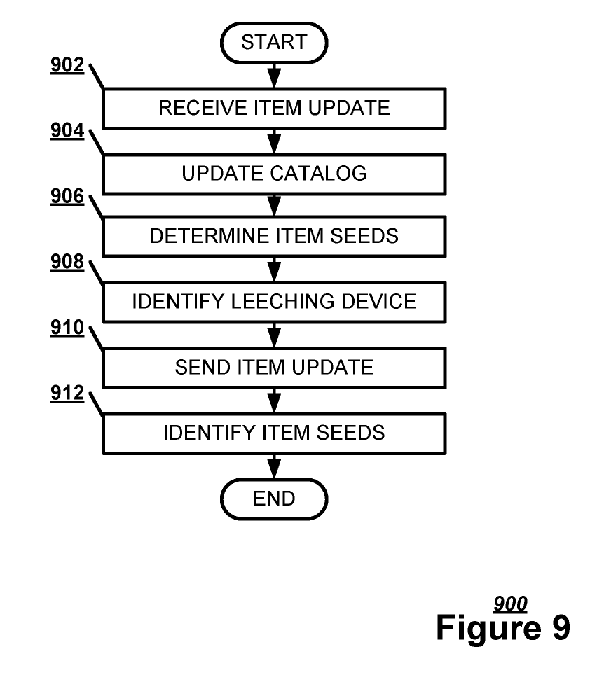

FIG. 9 illustrates, in a flowchart, one example of a method 900 of alerting a leeching device to a data content item with a catalog service. The catalog service may receive an item catalog update describing a data content item added to the data content set (Block 902). The catalog service may update a content catalog describing a data content set for the device group to add an item descriptor for the data content item (Block 904). The catalog service may determine an item seed device subset of the device group storing at least one item sub-piece of the data content item (Block 906). The catalog service may identify an item leeching device of the device group that has yet to receive the data content item (Block 908). The catalog service may send an item update alert to an item leeching device of the device group announcing the data content item (Block 910). The catalog service may identify the item seed device subset to an item leeching device of the device group to trigger the item leeching device to receive the data content item over a peer-to-peer network between the item seed device subset and the item leeching device (Block 912).

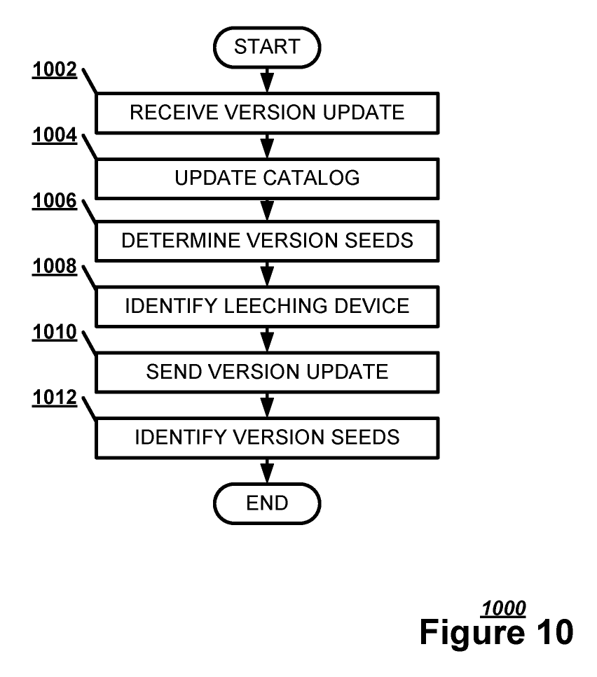

FIG. 10 illustrates, in a flowchart, one example of a method 1000 of alerting a leeching device to an updated version of a data content item with a catalog service. The catalog service may receive a version catalog update indicating the data content item has been updated to an updated version of the data content item (Block 1002). The catalog service may update a version identifier indicating the data content item and a version of the data content item in a content catalog describing a data content set for the device group (Block 1004). The catalog service may determine a version seed device subset of the device group storing at least one version sub-piece of an updated version of the data content item (Block 1006). The catalog service may identify a version leeching device of the device group that has yet to receive the updated version of the data content item (Block 1008). The catalog service may send a version update alert to a version leeching device of the device group to an updated version of the data content item (Block 1010). The catalog service may identify a version seed device subset of the device group having an updated version of the data content item to a version leeching device of the device group to trigger the version leeching device to receive the updated version over a peer-to-peer network between the version seed device subset and the version leeching device (Block 1012).

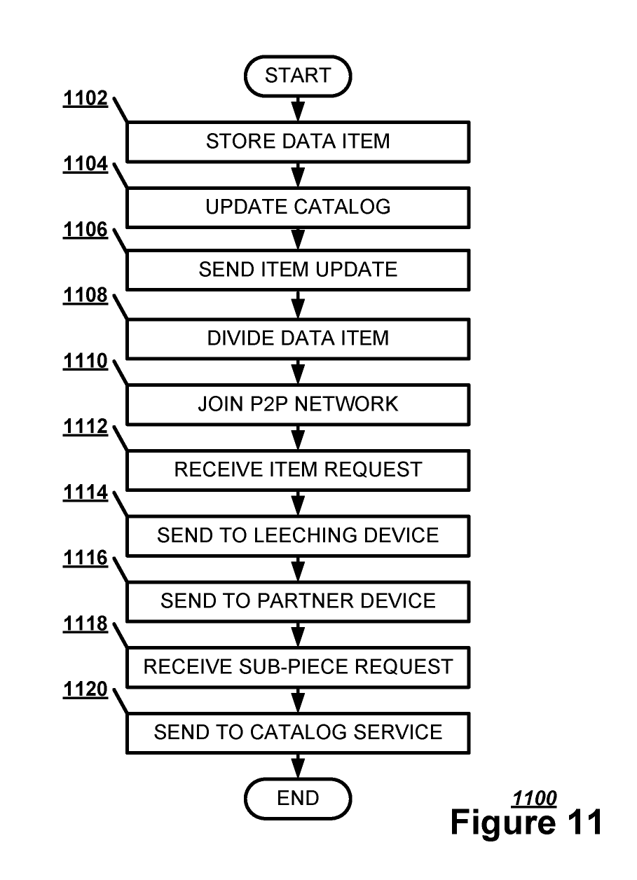

FIG. 11 illustrates, in a flowchart, one example of a method 1100 of transferring a data content item to a leeching device with a member device of a device group. The member device may store a data content item (Block 1102). The member device may update a content catalog describing a data content set for the device group to add an item descriptor for the data content item (Block 1104). The member device may send an item catalog update having the item descriptor to a catalog service to update the content catalog (Block 1106). The member device may divide the data content item into a sub-piece set having sub-pieces of equal data size (Block 1108). The member device may join a peer-to-peer network with an item leeching device and an item partner device of the device group (Block 1110). The member device may receive an item request from the item leeching device and the item partner device of the device group (Block 1112). The member device may transfer the data content item to the item leeching device over the peer-to-peer network by sending a leeching sub-piece subset of the sub-piece set to the item leeching device for transference to the item partner device and for merging with a partner sub-piece subset from the item partner device into a leeching copy of the data content item (Block 1114). The member device may send the partner sub-piece subset to the item partner device for transference to the item leeching device and for merging with the leeching sub-piece subset into a partner copy of the data content item (Block 1116). The member device may receive a request from the catalog service for at least one item sub-piece of the data content item (Block 1118). The member device may send the at least one item sub-piece to the catalog service to be merged into a network copy (Block 1120).

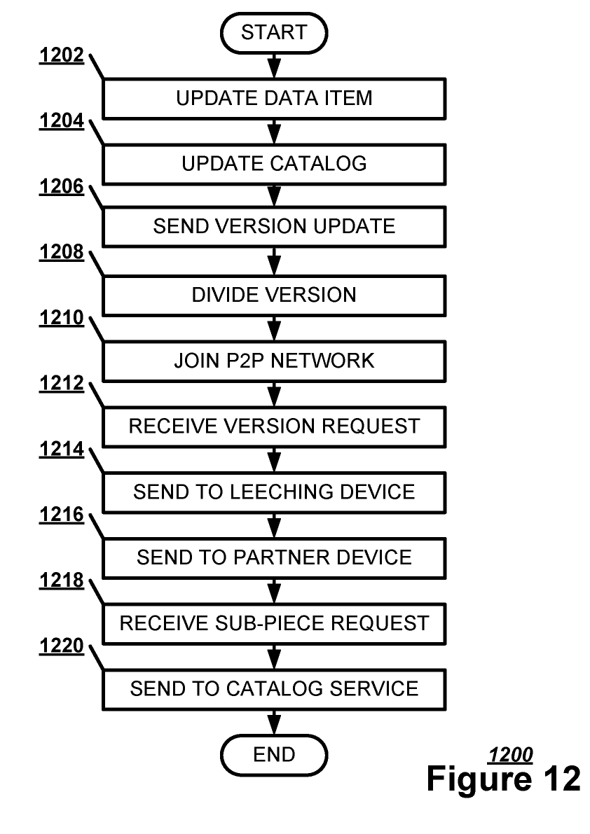

FIG. 12 illustrates, in a flowchart, one example of a method 1200 of transferring an updated version of a data content item to a leeching device with a member device of a device group. The member device may update a data content item to an updated version (Block 1202). The member device update a version identifier indicating the data content item and a version of the data content item in a content catalog describing a data content set for the device group (Block 1204). The member device may send a version catalog update indicating the data content item has been updated to an updated version of the data content item (Block 1206). The member device may divide the updated version into a sub-piece set having sub-pieces of equal data size (Block 1208). The member device may join a peer-to-peer network with a version leeching device and a version partner device of the device group (Block 1210). The member device may receive a version request from the version leeching device and the version partner device (Block 1212). The member device may transfer the updated version to the version leeching device over the peer-to-peer network by sending a leeching sub-piece subset of the sub-piece set to the version leeching device for transference to the version partner device and for merging with a partner sub-piece subset from the partner device into a leeching copy of the updated version of the data content item (Block 1214). The member device may send the partner sub-piece subset to the version partner device for transference to the version leeching device and for merging with the leeching sub-piece subset into a partner copy of the updated version of the data content item (Block 1216). The member device may receive a request from the catalog service for at least one version sub-piece of the updated version of the data content item (Block 1218). The member device may send the at least one version sub-piece to the catalog service to be merged into a network version copy (Block 1220).

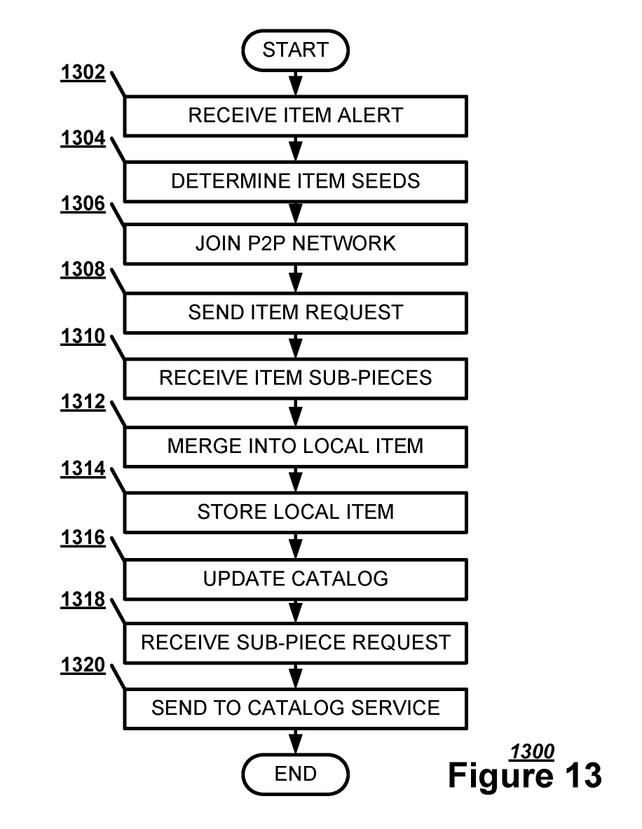

FIG. 13 illustrates, in a flowchart, one example of a method 1300 of receiving a data content item from a seed device with a member device of a device group. The member device may receive an item update alert announcing a data content item (Block 1302). The member device may determine an item seed device subset of the device group having the data content item divided into an item seed sub-piece subset (Block 1304). The member device may join a peer-to-peer network with the item seed device subset (Block 1306). The member device may send an item request to the item seed device subset (Block 1308). The member device may receive the data content item by receiving the item seed sub-piece subset from the item seed device subset of the device group over the peer-to-peer network (Block 1310). The member device may merge the item seed sub-piece subset into a local copy of the data content item (Block 1312). The member device may store the local copy of the data content item (Block 1314). The member device may update the content catalog to reflect the addition of the data content item (Block 1316). The member device may receive a request from the catalog service for at least one item sub-piece of the data content item (Block 1318). The member device may send the at least one item sub-piece to the catalog service to be merged into a network copy (Block 1320).

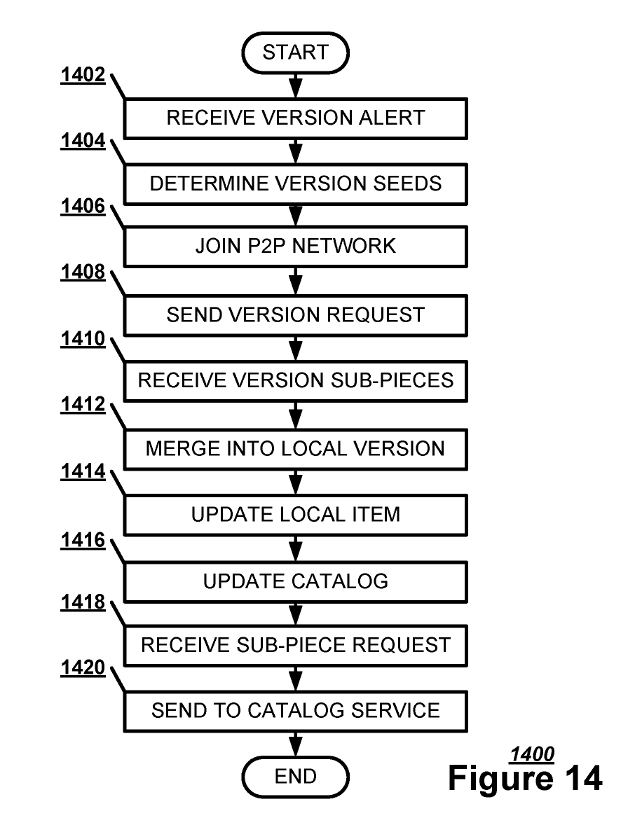

FIG. 14 illustrates, in a flowchart, one example of a method 1400 of receiving an updated version of a data content item from a seed device with a member device of a device group. The member device may receive a version update alert announcing an updated version of a data content item (Block 1402). The member device may determine a version seed device subset of the device group having an updated version of the data content item divided into a version seed sub-piece subset (Block 1404). The member device may join a peer-to-peer network with the version seed device subset (Block 1406). The member device may send a version request to the version seed device subset (Block 1408). The member device may receive an updated version of the data content item by receiving the version seed sub-piece subset from the version seed device subset of the device group over the peer-to-peer network (Block 1410). The member device may merge the version seed sub-piece subset into the updated version of the data content item (Block 1412). The member device may update the data content item based on the updated version (Block 1414). The member device may update the content catalog to reflect the updated version of the data content item (Block 1416). The member device may receive a request from the catalog service for at least one version sub-piece of the updated version of the data content item (Block 1418). The member device may send the at least one version sub-piece to the catalog service to be merged into a network version copy (Block 1420).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A catalog service, comprising:
memory configured to maintain a device group list describing a device group and a content catalog for the device group listing a data content set stored in the device group;
a processing core having at least one processor is configured to identify a content change to the data content set listed in the content catalog at a seed device of the device group; and
a communication interface configured to send an update alert to a leeching device of the device group of the content change to trigger the leeching device to receive the content change over a peer-to-peer network between the seed device and the leaching device.

2. The catalog service of claim 1, wherein the content change is at least one of an addition of a data content item to the data content set and an updated version of an existing data content item in the data content set.

3. The catalog service of claim 1, wherein the memory is further configured to tag the data content item for tracking by the catalog service.

4. The catalog service of claim 1, wherein the processing core is further configured to identify the item leeching device as having yet to receive the data content item.

5. The catalog service of claim 1, wherein the communication interface is further configured to identify an item seed device subset storing at least one sub-piece of the content change to the leeching device of the device group to trigger the leeching device to receive the at least one sub-piece over the peer-to-peer network between the seed device subset and the leaching device.

6. The catalog service of claim 1, wherein the memory is further configured to associate the device group with a group identifier describing at least one of a user identifier and a household identifier.

7. The catalog service of claim 1, wherein the communication interface is further configured to receive a catalog update from the seed indicating a content change to the data content set.

8. The catalog service of claim 1, wherein the memory is further configured to store a version identifier indicating the data content item and a version of the data content item.

9. The catalog service of claim 1, wherein the communication interface is further configured to upload at least one sub-piece of a content change of the data content set from each seed device in a seed device subset of the device group.

10. The catalog service of claim 1, wherein the processing core is further configured to merge sub-pieces of a content change received from a seed device subset of the device group into a network copy of the content change stored in the catalog service.

11. A computing device, having a memory to store a series of instructions that are executed by at least one processor to implement a catalog service application, the computing device configured to
maintain on the catalog service a content catalog for a device group listing a data content set stored in the device group;
receive an item catalog update describing a data content item added to the data content set;
identify an item seed device subset of the device group storing at least one item sub-piece of the data content item;
connect with the item seed device subset;
upload the at least one item sub-piece of the data content item from each item seed device in the item seed device subset; and
merge the item sub-pieces of the data content item into a network copy of the data content item stored in the catalog service.

12. The computing device of claim 11, wherein the computing device is further configured to
tag the data content item for tracking by the catalog service.

13. The computing device of claim 11, wherein the computing device is further configured to
identify an item leeching device of the device group that has yet to receive the data content item.

14. The computing device of claim 11, wherein the computing device is further configured to send an item update alert to an item leeching device of the device group announcing the data content item.

15. The computing device of claim 11, wherein the computing device is further configured to
identify the item seed device subset to an item leeching device of the device group to trigger the item leeching device to receive the data content item over a peer-to-peer network between the item seed device subset and the item leaching device.

16. The computing device of claim 11, wherein the computing device is further configured to
receive a version catalog update indicating the data content item has been updated to an updated version of the data content item.

17. The computing device of claim 11, wherein the computing device is further configured to
upload at least one version sub-piece of an updated version of the data content item from each version seed device in a version seed device subset of the device group; and
merge the version sub-pieces of the updated version into a network version copy of the updated version stored in the catalog service.

18. The computing device of claim 11, wherein the computing device is further configured to
identify a version seed device subset of the device group having an updated version of the data content item to a version leeching device of the device group to trigger the version leeching device to receive the updated version over a peer-to-peer network between the version seed device subset and the version leaching device.

19. A machine-implemented method, comprising:
storing a data content item on a member device of a device group;
updating a content catalog describing a data content set for the device group to add an item descriptor for the data content item;
joining a peer-to-peer network with an item leeching device of the device group; and
transferring the data content item to the item leeching device over the peer-to-peer network.

20. The method of claim 19, further comprising:
receiving an updated version of the data content item from a version seed device subset of the device group having an updated version of the data content item over the peer-to-peer network.
